(19) United States
(12) Patent Application Publication
(10) Pub. No.: US 2002/0163526 A1
(43) Pub. Date: Nov. 7, 2002

(54) Color management filters

(75) Inventors: Eric C. Haseltine, Burbank, CA (US); Charles F. Harrison, Snohomish, WA (US)

Correspondence Address: Attn: Christopher Darrow, OPPENHEIMER WOLFF & DONNELLY LLP, 38th Floor, 2029 Century Park East, L.A., CA, 90067, US

(73) Assignee: Disney Enterprises, Inc.

(21) Appl. No.: 09/849,038

(22) Filed: May 4, 2001

(51) Int. Cl. G09G 5/02

(52) U.S. Cl. 345/589

(57) ABSTRACT

A visible band filter with bandstops that restrict the spectrum of a projected or directly-viewed electronic display. The filter is placed between an observer's eye and the display, increasing the effective gamut of the electronic display without requiring any modification of the display hardware. The filter's bandstops are designed to shift the primary colors of the display closer to the spectrum locus, thereby increasing the color fidelity of the display.

### BACKGROUND OF THE INVENTION

1. Field of the Invention

This invention relates in general to the field of visible band filters for video display devices and similar objects. More particularly, the invention relates to restricting the spectral bandpass of the component primary colors in the spectra emitted by these display devices for the purpose of controlling their color gamut to improve color management prediction methods and display impact.

2. Description of Related Art

Video display devices are widely used in articles such as televisions, computer monitors, video game screens, projection screens and apparatuses, and the like. Generally, these devices are equipped with a cathode ray tube (CRT). A CRT is a glass, vacuum tube that works by moving an electron beam through many passes across the back of the screen. As the beam makes each pass it activates phosphors, converting the electron energy into light energy. With enough passes, the entire area of the screen becomes filled with images of color.

The colors that are produced on video display devices represent only a portion of the entire range of colors: those possible through combination of the three additive primary colors—red, green and blue (RGB). This range may be visually represented as an approximate triangle, within the boundaries of the Standard Chromaticity Diagram standardized by the Commission Internationale d'Eclairage (CIE). Use of the word “gamut” in this disclosure denotes a range of color hue and purity, and may be represented by a contiguous region of the Chromaticity Diagram. A larger region represents a wider range, or larger gamut, of colors, while a smaller region represents a reduced color gamut. The largest possible region then would represent the entire range of colors created by all possible combinations of the spectral colors, and would be bound by the spectral locus and line of purples in the Standard Chromaticity Diagram.

The gamut of an additive RGB system, such as a CRT, is limited to a triangle with vertices defined by the colors of the three individual primaries (phosphors, for a CRT). To achieve the fullest possible range of colors, these primaries should be spectrally pure, that is, narrow-band, and the primaries should be widely spaced in hue. In many electronic displays, such as CRT screens, narrow-band primaries are not practical because spectrally-pure primaries lack sufficient energy to provide a bright image. In addition, the colors of practical phosphors are limited by many technical and economic considerations, and may not be optimally spaced in hue.

In addition to limitations incurred by restricted color gamuts, it is difficult to accurately predict appearance of a single image on a variety of displays. Different video display devices are capable of different color gamuts. For example, a CRT monitor has a larger color gamut than an LCD flat panel monitor. Different still are the color gamuts available to various types of motion picture film, color lithography, or various other forms of print media. Achieving consistent color results for a single image that may be displayed in any number of ways with any number of color gamuts presents a significant challenge.

One of the most challenging problems in any color management system is to achieve accurate electronic prediction of colors that are printed onto the final media. For example, with the rapidly growing use of computer graphics in film, it is difficult to predict on a computer's CRT or flat panel display monitor what the graphics will actually look like on film. This prediction is difficult because CRT and flat panel monitors have different color gamuts than film.

A related problem is that film is capable of representing colors that are simply not available to the monitors. Thus, it is not possible to faithfully reproduce certain film colors on a CRT or flat panel monitor. These difficulties in achieving consistency and accurate predictions translate to high costs for pre-production and production of films.

Still another problem that arises from the reduced color gamut of various display devices is the affect on single aperture projection systems. Typical of the past were color CRT projectors that were equipped with three lenses. As each of the lenses was devoted to one of the three primary colors, each lens could be individually filtered to emit a clean spectrum closely matching an ideal red, green or blue wavelength. By placing notch or edge filters over each of the three primary color projection channels, the color gamut of the projector could be increased. Today however, single lens projectors such as liquid crystal or DMD projectors are becoming more prevalent. Simple edge and notch filters will not work with single aperture projectors. These projectors would require a comb, or multiple bandstop, filter. The same is true for single screen direct view displays such as CRT or LCD monitors.

Traditional gels and interference filters can limit the spectral bandwidth of primary color emitters of electronic displays, thereby widening their color gamut. However, gel filters, used either singly or in combination, cannot be made with the repeatable precision needed for accurate colorimetry. Also, gel filters fade as time passes. While interference filters can be made with repeatable bandpasses and do not fade, single interference filters cannot be made with multiple bandstops. Further, single interference filters generally lack the very steep bandstop cutoffs desired for precision colorimetry. There is no currently known means for providing a suitable filter to a single lens projector or electronic display device such that the effective color gamut can be substantially increased and predictability involving different display devices can be significantly improved.

### SUMMARY OF THE INVENTION

Accordingly, it is a purpose of the invention to achieve accurate color prediction on electronic display devices by increasing their effective color gamut without having to modify the devices. It is a further object of the invention to expand the gamut of direct view and projection displays employed in entertainment and information applications, such as theme parks, retail stores, motion picture exhibitions and other venues in order to increase the impact and perceived quality of these displays. More specifically, the present invention seeks to increase the color gamut of display devices by restricting the spectral bandpass of the component primaries of a single screen or single aperture electronic display through the use of a single filter. The invention further seeks to utilize the modified color gamuts by compensating a color signal input to the display device to account for the modified color gamut.

The foregoing and other objects, features, and advantages of the present invention will be apparent from the following detailed description of the preferred embodiments which makes reference to several drawing figures.

### BRIEF DESCRIPTION OF THE DRAWINGS

FIG. 1 is a chromaticity diagram that depicts CRT panel and LCD panel color gamuts relative to the spectrum locus of all possible colors.

FIG. 2 is a chromaticity diagram showing the difference between a CRT screen color gamut and a color gamut of film.

FIG. 3 is a chromaticity diagram that compares a typical CRT color gamut with a color gamut of a CRT that is filtered according to an embodiment of the present invention.

FIG. 4 is the phosphor emission spectrum of a typical CRT display device.

FIG. 5 is a modified spectrum according to a CRT display device that has been filtered according to an embodiment of the present invention.

FIG. 6 depicts transmission plot characteristics of a rugate filter according to an embodiment of the present invention.

FIG. 7 shows the components of an exemplary color correction system featuring a single filter and a color signal translator to achieve an increased color gamut.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized and structural and functional changes may be made without departing from the scope of the present invention.

In view of the aforementioned objects of the invention, a system for managing the color gamut of electronic or projection displays is disclosed herein. Colors can be simply described by using the tristimulus system of measurement. The CIE tristimulus system is based on visually matching of colors under standardized conditions; it allows each perceived color to be described by three tristimulus values: X, Y, and Z. For example, the tristimulus values for a particular green CRT phosphor are X=30, Y=60, Z=10. These values specify not only hue and purity but also relate to perceived brightness, since they are calculated in such a way that the Y value equals the phosphor's luminance (60 candelas per square meter in this example).

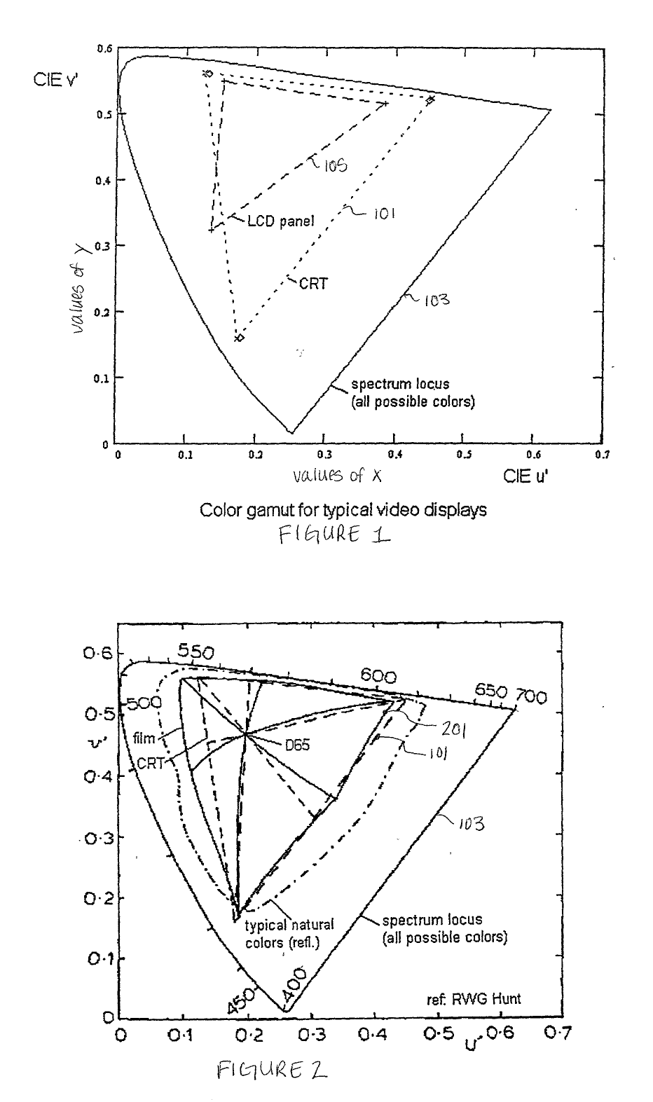

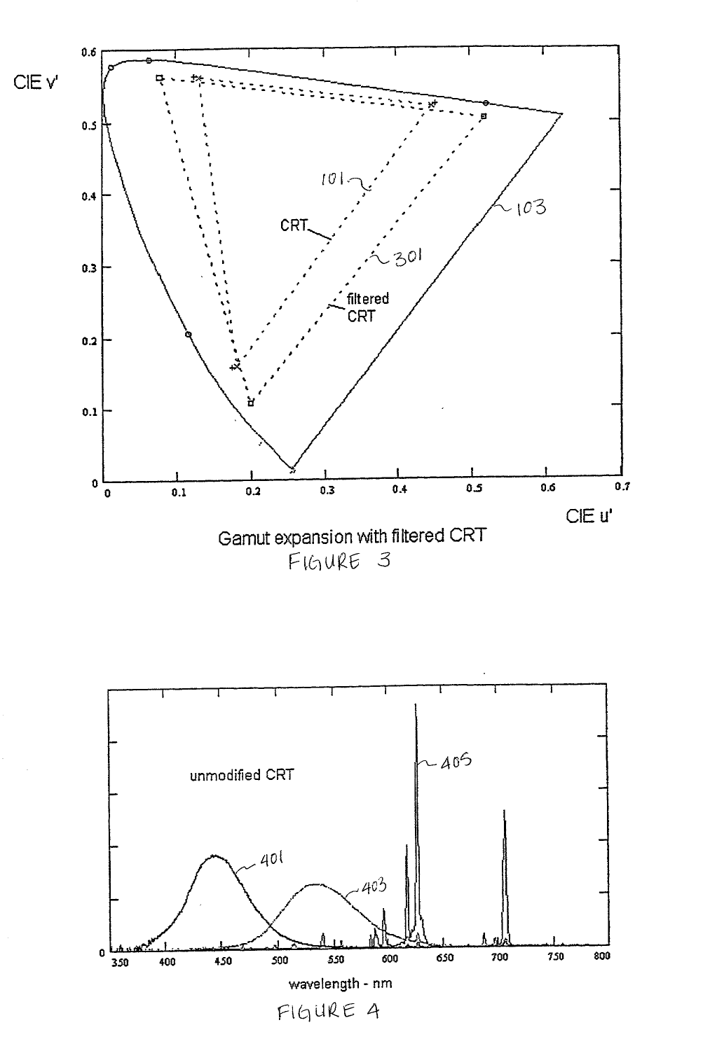

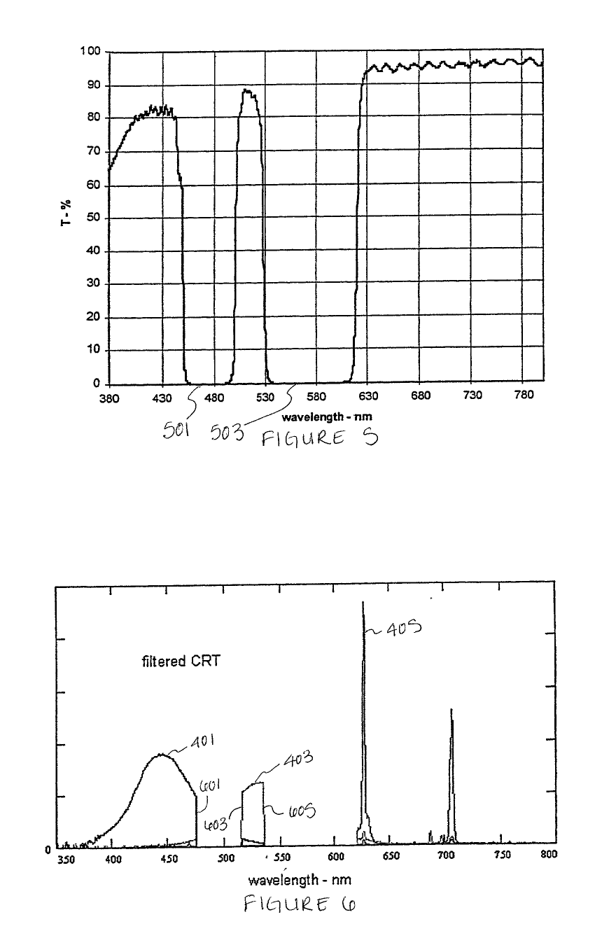

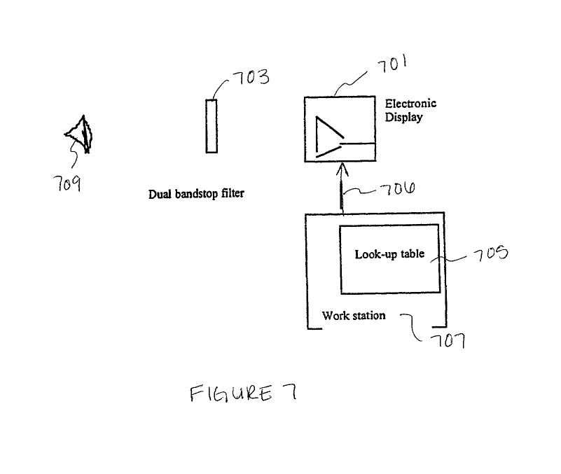

Color data can be graphically represented on a chromaticity diagram. This is depicted in FIG. 1 as the CIE color gamut 103 representing all possible colors. Standardized by the Commission Internationale d'Eclairage (CIE) in 1976, the chromaticity diagram used here is based on the values u′, v′ where u′=4X/(X+15Y+3Z), v′=9Y/(X+15Y+3Z). The u′ and v′ together constitute the chromaticity of a sample. Light and dark colors that have the same chromaticity (and are therefore plotted at the same point on the two-dimensional chromaticity diagram) are distinguished by their different Y values (luminance or visually perceived brightness).

FIG. 1 depicts the color gamuts of CRT and LCD displays within the boundaries of a Standard Chromaticity Diagram. As shown in FIG. 1, the CRT color gamut 101 of a typical CRT display is smaller than the CIE color gamut 103 representing all possible colors. Smaller still is the LCD color gamut 105 of a typical LCD display panel. FIG. 2 depicts another inconsistency among color gamuts by comparing the CRT chromaticity diagram 101 of a CRT display device with a film chromaticity diagram 201 representative of motion picture film.

Addressing an object of the invention to increase the color gamuts of such display devices such that consistency may be achieved across a variety of media and display devices, and referring to FIG. 7, a filter 703 is situated such that it will filter the output of the display devices 701. The filter 703, which according to an embodiment of the invention may have bandstops that restrict the spectrum of a projected or directly viewed electronic display, is placed between an observer's eye 709 and the display 701. The effective color gamut, namely, the color gamut seen by observer's eye 709, is thereby increased as shown in FIG. 3, which depicts a CRT chromaticity diagram 101 of a typical CRT screen and a filtered CRT chromaticity diagram 301 of a CRT screen with a filtered display output.

The primary colors are normally represented by broadband spectra in CRT monitors and other electronic display devices in order to achieve sufficient brightness. Primary color spectra typical of a CRT display device are shown in FIG. 4, which depicts the typical broad band spectra of blue 401 and green 403 wavelengths, as well as the typical spectrum for red 405. To produce an increase in the perceived color gamut of a display device 701, an optical filter 703, according to one embodiment of the present invention, has properties such that component primary colors in the display 701 output are bandlimited, thereby increasing color purity. This may be accomplished, for example, by the filter having a stop region located between wavelengths corresponding to two additive primary colors or peaks centered approximately at the primary color wavelengths. Another possibility is a dual bandstop filter. According to an embodiment of the present invention, the basic operation of electronic display devices would be unchanged, such that broadband primaries are still being used. Although the perceived brightness may be reduced, the effective color gamut visible to an observer's eye 709 may be improved by narrowing the spectral bandwidths of the primary colors in the output of the display devices, by means of the filter 703 as described previously.

A preferred filter for use in the system disclosed herein, according to an embodiment of the invention, is a single rugate filter, with bandstop characteristics similar to those shown in FIG. 5, providing a first bandpass region 501 between about 455 nm and 500 nm, and a second bandpass region 503 between about 530 nm and 620 nm. The effect of a filter exemplary of this embodiment on a CRT display is shown, for example, in FIG. 6. Relatively steep cutoffs are applied to the red 401 and green 403 spectra at locations 601, 603 and 605. This has the effect of narrowing the primary color spectra 401 and 403 so that greater color gamuts can be achieved.

Other kinds of filters may be used, and other bandstop characteristics may be employed for filtering the component primaries. Bandpass filters centered around the primary color frequencies may be used, as well as various kinds of bandstop or notch filters, with notches centered between approximately 450 nm and 515 nm and 530 nm and 620 nm, respectively. Further, combinations of two rugate or interference filters with low and high bandstops, respectively, will also achieve a widening of the color gamut. These combinations may not be preferred methods in an embodiment of the invention pertaining to projection displays, however, as multiple filter combinations require laminations that may not withstand the heat of projection displays.

According to another embodiment of the invention, the system may be adjusted to provide varying characteristics in the increased color gamut of a filtered display output. For example, a CRT display output may be processed and filtered such that the effective color gamut encompasses the color gamuts of film, color lithography, and photographic prints, and the system would have the ability to access specific portions of the effective color gamut such that it emulates the color gamut of film, color lithography, or various photographic prints. Use of the term “emulation” herein refers to consistent color representation made possible by the formation and use of consistent color gamuts.

An exemplary system is shown in FIG. 7 and includes a CRT display device 701 and a filter 703 placed between the CRT 701 and observer's eye 709. A color signal translator 705 provides the ability to modify system inputs, such as digital color signals, at a computer workstation 707. Color signal translators are commonly used in the art. In the present invention, color signal translator 705 modifies color inputs, representing a reduced color gamut, to correspond to the portion of the increased color gamut to be displayed in the system output, viewable at observer's eye 709. That is, color signal translator 705 re-maps the color of each pixel from an input signal to a different color for the output signal, having a larger “palette” of colors available for the re-mapping process. The result is that the colors represented in the input signal are stretched over a broader color gamut, enhancing the color of the overall image that is sent in the output signal to the display device. It should be understood that invention may be used with any kind of display device. For example, the image may be projected, as onto a screen, and that the observer may view the projection, rather than a CRT. The filter 703 may be placed between the screen and projector raster or between the screen and the observer.

In an exemplary embodiment, to enable the effective color gamut to accurately represent an image as it would appear on film, the system would compensate the input color signal 706 such that the signal would comprise all portions of the film color gamut 201 corresponding to film. Because the filtered CRT output would have a color gamut 301 that encompasses the film color gamut 201, the image represented by the input signal would be accurately viewed by observer's eye 709 as it would appear on film.

An exemplary color signal translator 705 utilizes a lookup table (LUT) 705. In an embodiment of the invention, which includes the LUT 705 of 3-dimensional type in the system, an RGB color signal input is modified by the LUT 705, which results in new RGB signal components based on the values within LUT 705. For example, a digital input signal representing an image according to a photographic film encoding such as “Cineon” may be passed through a LUT 705 to produce additive RGB values. Then, when the signal is translated and displayed on a CRT 701 whose output is filtered by a filter 703 according to an embodiment of the invention whereby the effective color gamut 301 includes the color gamut of film 201, the image will appear to an observer's eye 709 as it would had the original digital data been recorded on film. Without filter 703, the observable colors are limited to the typical CRT gamut 101 and the film color cannot be faithfully reproduced.

LUT 705 may be varied within the system depending on particular applications. For example, a signal to be viewed as it would appear on color motion picture film would use a different LUT 705 than if it were to be viewed as it would appear on color lithography. Thus, each form of medium to be emulated would have its own LUT 705 associated with it. Values entered into the LUT 705 for a particular medium to be emulated would depend on various properties of that medium. The properties may include, but are not limited to, the color gamut, gamma and dynamic range of that medium.

The foregoing description of the preferred embodiments of the invention has been presented for the purposes of illustration and description. It is not intended to be exhaustive or to limit the invention to the precise form disclosed. Many modifications and variations are possible in light of the above teaching. For instance, other kinds of filters may be employed that relatively attenuate non-primary colors relative to primary frequencies. Likewise, other kinds of filters that emphasize primary colors relative to non-primary colors may be employed. The filters may be used to filter the output of electronic display devices other than CRT or LCD types, including all types of single aperture projection display devices. The translator for altering a color signal to compensate for the primary color filtering may include tools other than a lookup table. For example, various kinds of algorithms may be used to determine and assert compensation of a color signal. Types of media to be emulated by an electronic display device may include any medium that displays colors comprising combinations of primary colors. Moreover, it will be appreciated by those skilled in the art that the primary colors need not be limited to the three additive primaries, and that any two or more colors may be used as primary colors whose spectra are filtered in a system according to the present invention.

It will be appreciated that the term “present invention” as used herein should not be construed to mean that only a single invention having a single essential element or group of elements is presented. Rather, each novel and nonobvious element constitutes a separate invention. Further, each novel and nonobvious combination of elements enabled by the present disclosure, whether the individual elements therein are old elements, new elements, or any combination thereof, further constitutes an additional separate invention.

What is claimed is:

1. A visual display system having an improved color gamut, comprising:
a display device;
a color signal translator;
input color data;
the color signal translator translating the input color data according to properties of a medium to be emulated by the display device;
the display device receiving and displaying the translated color data;
an optical filter;
the optical filter filtering an output of the display device; and
the optical filter having a stop region located between wavelengths corresponding to two additive primary colors.

2. A visual display system according to claim 1 wherein said properties include a color gamut, gamma, and dynamic range of the medium to be emulated.

3. A visual display system according to claim 1 wherein said filter has at least a first peak centered at approximately either one of red, green, or blue wavelengths.

4. A visual display system according to claim 1 wherein said filter is a rugate filter.

5. A visual display system according to claim 1 wherein said filter is a dual bandstop filter.

6. A visual display system according to claim 1 wherein said filter comprises: a first notch centered between about 450 nm and 515 nm; and a second notch centered between about 530 nm and 620 nm.

7. A color gamut adjusting system for a visual display system, comprising:
a translator for translating a digital color signal display system input according to properties of a medium to be emulated by the display system; and
a filter that filters an output of the display system, said filter relatively attenuates non-primary colors;
whereby color purity of the display output is increased, thereby increasing the display's color gamut.

8. A color gamut adjusting system according to claim 7 wherein said properties include a color gamut, gamma, and dynamic range of the medium to be emulated.

9. A color gamut adjusting system according to claim 7 wherein said filter is a rugate filter.

10. A color gamut adjusting system according to claim 7 wherein said filter is a dual bandstop filter.

11. A color gamut adjusting system according to claim 7 wherein said filter comprises a first notch centered between about 450 nm and 515 nm , and a second notch centered between about 530 nm and 620 nm .

12. A visual display system comprising:
a data input port for receiving a digital color signal input;
said signal comprising at least one component primary color from the group consisting of red, green, and blue;
a lookup table for processing said color signal input according to properties of a medium to be emulated by said color display device and producing a translated color signal output;
a color display device for receiving and displaying said translated color signal;
a filter for filtering an output of said color display device; and
wherein said filter has at least one of a notch centered between about 450 nm and 515 nm and a notch centered between about 530 nm and 620 nm .

13. A visual display system according to claim 12 wherein said properties of the medium to be emulated comprise a color gamut, gamma, and a dynamic range.

14. A visual display system comprising:
a means for altering a digital color signal according to a color gamut to be produced and producing an altered digital color signal;
a single aperture projector receiving said altered digital color signal;
a filter for filtering a projection of light from said projector; and
said filter altering the spectral bandwidths of at least one of said component primaries of said projection; whereby said color gamut is produced.

15. A visual display system according to claim 14 wherein said filter is a rugate filter.

16. A visual display system according to claim 14 wherein said filter is a dual bandstop filter.

17. A visual display system according to claim 14 wherein said filter comprises:
a first notch centered between about 450 nm and 515 nm; and
a second notch centered between about 530 nm and 620 nm .

18. A visual display system comprising:
a color display device;
a lookup table which processes a color signal according to properties of a medium to be emulated by the color display device to produce a processed color signal;
the color display device receiving and displaying the processed color signal as a display; and
a filter which filters the display.

19. A visual display system according to claim 18 wherein said filter includes a first notch centered between about 450 nm and 515 nm and a second notch centered between about 530 nm and 620 nm .

20. A visual display system according to claim 18 wherein the color signal comprises at least one component primary color from the group of red, green and blue.

21. A visual display system according to claim 18 wherein said color display device comprises a cathode ray tube display device.

22. A visual display system comprising:
an electronic display device having a display; and
a filter positioned relative to the display and having bandstops which increase color gamut of the display wherein the bandstops shift the primary colors of the display closer to the spectrum locus.

23. A visual display system according to claim 22 wherein the bandstops provide a first notch centered between about 450 nm and 515 nm and a second notch centered between about 530 nm and 620 nm .

24. A visual display system comprising:
a cathode ray tube display device; and
a filter which filters a display of said display device so as to increase the effective gamut of said display device, said filter having bandstops which shift primary colors of the display to increase color gamut of the display.

25. A process for altering a color gamut of a visual display system, comprising:
processing a digital color signal according to a color gamut, gamma, and dynamic range of a medium to be emulated;
delivering the processed color signal to an electronic display device; and
filtering an output of said display device to purify primary colors within the output, whereby the color gamut of the display system is altered.

26. A method of producing a motion picture having digital imagery therein, comprising:
emulating the appearance of color film by: modifying an additive color display device to emulate a color gamut of film;
displaying a draft digital image on said modified additive color display device;
amending said digital image to create final digital color imagery; and
producing a film from said amended digital color imagery.

27. A system of improving the appearance of a color display, comprising:
a filter at the output of the display, the filter relatively attenuating non-primary colors; and
a lookup table for receiving a digital color input signal and for compensating the digital color input signal with reference to a response of said filter, such that the filtered display output has an increased color gamut.
